(19) United States
(12) Patent Application Publication
(10) Pub. No.: US 2024/0198493 A1
(43) Pub. Date: Jun. 20, 2024

(54) Adjustable Locking Plier Device

(71) Applicant: Eduardo Mendoza Alvarado, Visalia, CA (US)

(72) Inventor: Eduardo Mendoza Alvarado, Visalia, CA (US)

(21) Appl. No.: 18/083,573

(22) Filed: Dec. 19, 2022

(51) Int. Cl. B25B 7/12; B25B 7/02

(52) U.S. Cl. CPC B25B 7/123; B25B 7/02

(57) ABSTRACT

An adjustable locking plier device includes a handle, a locking clamp having a straight jaw member and an angled jaw member, each jaw member having a length with proximal and distal ends. The straight jaw member has no points of directional change along its length, the angled jaw member has at least one point of directional change along its length, and each jaw member has a contact portion for receiving clamping force. The contact portion of the straight jaw member has at least twice the surface area of that of the angled jaw member and is included in the body of the straight jaw member as a shared surface. Both jaw members are pivotally engaged with the handle at their proximal ends, and the clamp is configured to lock within an infinite range bounded by a fully open and a fully closed position.

### FIELD OF THE INVENTION

This disclosure relates to the field of adjustable locking pliers and C-Clamps.

### BACKGROUND

Structural engineering and construction requires a certain set of specialized tools. When working with framing materials such as studs and furring channels, it is essential to utilize such tools safely and accurately in order to successfully adhere to strict building codes, while promoting the health and safety of construction workers. Large scale building construction in particular adheres to very strict safety protocols and building codes to promote occupant safety, fire safety, earthquake resistance, and the like, and often utilizes more metal framing materials such as galvanized steel studs and channels.

When working with such heavy-duty framing materials, gripping, clamping, cutting, fastening, assembling, riveting, welding and similar tasks must often be executed in very small spaces, out of necessity. Current tools of the trade, though usually quite effective, are not necessarily geared toward working well with framing materials under such cramped conditions, and in fact may prove to be unusable in certain instances. Locking C-Clamp pliers are a commonly used tool in such situations, however their large clamping width becomes a hindrance when working with framing materials in interior spaces, during the erection of walls, and having to reach in-between walls to fully install them or work with the structurally associated studs and furring channels. The combination of large, heavy materials and often limited workspaces further highlights the need in the art for proper specialized tools that can safely, quickly, and effectively execute very difficult construction tasks.

### SUMMARY

Systems for An adjustable locking plier device is provided. In an exemplary embodiment an adjustable locking plier device, comprises a locking clamp, the locking clamp comprising a straight jaw member and an angled jaw member, each jaw member having a length with proximal end, and distal end, the straight jaw member having no points of directional change along its length, the angled jaw member having at least one point of directional change along its length, each jaw member further comprising a contact portion for receiving clamping force, wherein the contact portion of the straight jaw member has at least twice the surface area of that of the angled jaw member and is included in the body of the straight jaw member as a shared surface. The device further includes a handle comprising a first handle portion and second handle portion, both handle portions being in mechanical communication via a locking mechanism, wherein the lengths of both the straight jaw member and angled jaw member extend away from the handle starting from their proximal ends. The device further includes a tightness adjustor configured to adjust the clamp between a fully open and fully closed position and provide precision over-tightening when the clamp is locked, wherein the first handle portion terminates with the tightness adjustor at the end opposite the locking clamp. The device further includes a compressible quick release lever, wherein the second handle portion terminates with the quick release lever at the end opposite the locking clamp. Both jaw members are pivotally engaged with the handle at their proximal ends, wherein the clamp is configured to lock within an infinite range bounded by the fully open and fully closed positions, the contact portions of the jaw members being furthest from one another in the fully open position and making contact with one another in the fully closed position, and wherein the compressible quick release lever is configured to unlock the clamp from any position within the locking range.

In another embodiment of the adjustable locking plier device, the angled jaw member has two points of directional change along its length, including a first bend at its proximal end, this first bend extending away from the straight jaw member, and a second bend at its distal end, this second bend extending back toward the straight jaw member, wherein the portion lying between the two bends has a length that is over 90% similar to that of the contact portion of the straight jaw member, and wherein the contact portion of the straight jaw member occupies over 90% of the full length of the straight jaw member.

In one embodiment of the adjustable locking plier device, over 90% of the contact portion of the straight jaw member comprises teeth formed by alternating recessed and protruding surfaces, and wherein the contact portion of the angled jaw member is rounded. In one aspect of the adjustable locking plier device, the straight jaw member is pivotally engaged with the first handle portion and the angled jaw member is pivotally engaged with the second handle portion. In another aspect of the adjustable locking plier device, both contact portions are configured to grip framing materials within the range bounded by the fully open and fully closed positions.

In another embodiment of the adjustable locking plier device, the framing materials include stud members and furring channels each having a length, inner surfaces and outer surfaces, and an opening along the length. In another aspect of the adjustable locking plier device, the stud members include C-studs and CH-studs, and the furring channels include hat channels and resilient channels. In another aspect of the adjustable locking plier device, the studs each further comprise a web with a width and two flanges extending perpendicularly away from each end of the web, each flange having a depth and a lip extending perpendicularly away from an end of the flange opposite the web, the lips having widths and extending toward each other, a gap between the lips forming said lengthwise opening, and wherein the lengthwise opening leads into an inner area with inner surfaces of the lips, flanges, and web, each inner surface having a corresponding outer surface.

In one embodiment of the adjustable locking plier device, the contact portion of the angled jaw member makes contact with an inner surface of a flange, and the contact portion of the straight jaw member makes contact with an outer surface of said flange, wherein the length at the distal end of the angled jaw member between its contact portion and second bend is greater than that of the lip extending from said flange, and wherein the clamp is lockable in this position. In one aspect of the adjustable locking plier device, the clamp is configured to grip a framing material via insertion of the angled jaw member into the lengthwise opening such that its contact portion makes contact with an inner surface of the framing material, and wherein the contact portion of the straight jaw member makes contact with an outer surface of the framing material. In another aspect of the adjustable locking plier device, the clamp is configured to grip a framing material via insertion of the straight jaw member into the lengthwise opening such that its contact portion makes contact with an inner surface of the framing material, and wherein the contact portion of the angled jaw member makes contact with an outer surface of the framing material.

In another embodiment of the adjustable locking plier device, the clamp is configured to manipulate the framing materials within a portion of the locking range measuring between ¼ inch and 1½ inches. In one aspect of the adjustable locking plier device, the contact portion of the straight jaw member has over four times the length of that of the angled jaw member. In another aspect of the adjustable locking plier device, the straight jaw member maintains continuous surface contact along the full length of its contact portion.

### BRIEF DESCRIPTION OF THE DRAWINGS

FIG. 1 is a perspective view of adjustable locking pliers in an embodiment of the disclosed adjustable locking plier device.

FIG. 2 is a top view of adjustable locking pliers in a fully closed position in an embodiment of the disclosed adjustable locking plier device.

FIG. 3 is a left side view of adjustable locking pliers in an embodiment of the disclosed adjustable locking plier device.

FIG. 4 is another top view of adjustable locking pliers in a fully open position in an embodiment of the disclosed adjustable locking plier device.

FIG. 5 is yet another top view of adjustable locking pliers clamped onto a C-Stud in an embodiment of the disclosed adjustable locking plier device.

### DETAILED DESCRIPTION

In the following discussion, numerous specific details are set forth to provide a thorough understanding of the disclosed subject matter. However, those skilled in the art will appreciate that the present disclosed subject matter may be practiced without such specific details. In other instances, well-known elements, processes or techniques have been briefly mentioned and not elaborated on in order not to obscure the disclosed subject matter in unnecessary detail and description. Moreover, specific details and the like may have been omitted inasmuch as such details are not deemed necessary to obtain a complete understanding of the disclosed subject matter, and are considered to be within the understanding of persons having ordinary skill in the relevant art.

The present invention is optimized for use with structural and architectural framing materials. These materials often include metal stud members such as C-studs and CH-studs, and furring channels such as hat channels and resilient channels, which are installed onto existing walls. When the above-mentioned stud members and furring channels must be permanently fused together via welding or joined together with a screw, care must be taken within the adjacent existing walls when space between the walls and new framing members is insufficient for tools currently known in the art. The present invention is particularly useful when clamping space is limited to an approximate locking range of between ¼ inch and 1½ inches. Working in such tight spaces, the present invention allows for reliable manipulation of framing materials (where manipulation includes gripping, un-gripping, locking, and unlocking), preventing slipping and assuring proper alignment of the installed materials. In highlighting the benefits and strengths of the present invention, reference is made to specific physical features of studs and furring channels, for example the web, flanges, and lips which form a lengthwise opening in such framing materials, and the manner in which the present invention interacts with these specific elements. Such examples are illustrative in nature and do not necessarily imply limitations or a lack of other uses not mentioned herein.

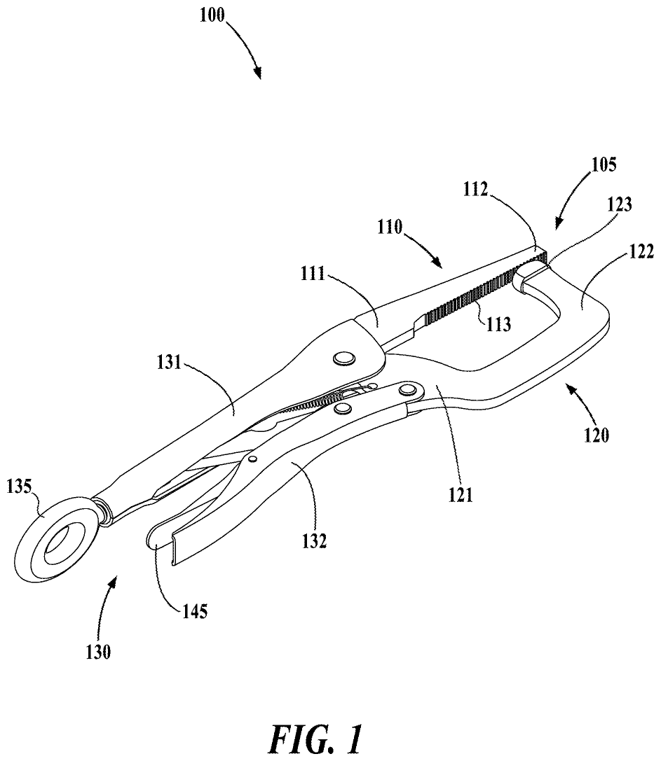

Referring to FIG. 1, an illustration shows a perspective view of adjustable locking pliers 100 in an embodiment of the disclosed adjustable locking plier device. The adjustable locking plier device 100 further comprises a locking jaw or clamp 105, and a handle 130. The locking clamp 105 further comprises a straight jaw member 110 with a proximal end 111 and a distal end 112. As well, the locking clamp 105 further comprises an angled jaw member 120 with its own proximal end 121 and distal end 122. Both jaw members 110 and 120 are pivotally engaged with the handle 130 at their respective proximal ends 111 and 121, and each has a length extending away from the handle 130 and terminating at their respective distal ends 112 and 122.

The straight jaw member 110 has no bends or points of directional change along its length, while the angled jaw member 120 has at least one point of directional change. The exemplary embodiment illustrated depicts two points of directional change, or angled bends along the length of the angled jaw member 120. This includes a first bend at its proximal end 121, this first bend extending away from the straight jaw member 110, and a second bend at its distal end 122, this second bend extending back toward the straight jaw member 110. The contrasting shapes of the jaw members 110 and 120 form a hybrid locking clamp 105 that offers greater versatility not only to grip a more varied group of construction materials, but also to do so in more varied environments—especially those with a limited workspace.

Each jaw member 110 and 120 further comprises a contact portion 113 and 123, respectively, for receiving clamping force. In the exemplary embodiment shown, substantially all of the gripping contact portion 113 of the straight jaw member 110 comprises teeth formed by alternating recessed and protruding surfaces along its length, running perpendicular to it. As used herein, “substantially” refers to approximately 90% or more. In contrast, the terminal contact portion 123 of the angled jaw member 120 is substantially smaller, and may be rounded in an exemplary embodiment. The gripping contact portion 113 of the straight jaw member 110 has at least twice the surface area of that of the angled jaw member 120. For example, the exemplary embodiment shown in the illustration depicts a much smaller terminal contact portion 123 of the angled jaw member 120 as compared with the gripping contact portion 113 of the straight jaw member 110, which here is approximately four or five times the length of the terminal contact portion 123 of the angled jaw member 120. As well, in the exemplary embodiment shown, the portion of the angled jaw member 120 lying between the two bends has a length that is over substantially similar to that of the gripping contact portion 113 of the straight jaw member 110. Additionally in such an embodiment, the gripping contact portion 113 of the straight jaw member 110 occupies over 90% of its full length.

The handle 130 further comprises a first handle portion 131 and second handle portion 132. In the position currently illustrated, the first handle portion 131 has a length axis that generally coincides with that of the straight jaw member 110, which is pivotally engaged with the first handle portion 131 at its proximal end 111. Likewise, the angled jaw member 120 is pivotally engaged with the second handle portion 132, and generally lies parallel with it for a substantial portion of its length, becoming more perpendicular to the second handle portion 132 at its first and second angled bends—which generally lie at the proximal and distal ends 121 and 122, respectively, of the angled jaw member 120. The first handle portion 131 further comprises a tightness adjustor 135 which is in mechanical communication with the locking clamp 105, such that rotating the tightness adjustor 135 affects the size of the clamp opening, and thus affects the applied clamping force when the clamp 105 has been locked, especially via precision overtightening. In the example shown, the first handle portion 131 terminates with the tightness adjustor 135 at the end opposite the locking clamp 105. Similarly, the second handle portion 132 further comprises a compressible quick release lever 145 that can unlock the clamp 105 from any position within a locking range. The second handle portion 132 terminates with the quick release lever 145 at the end opposite the locking clamp 105.

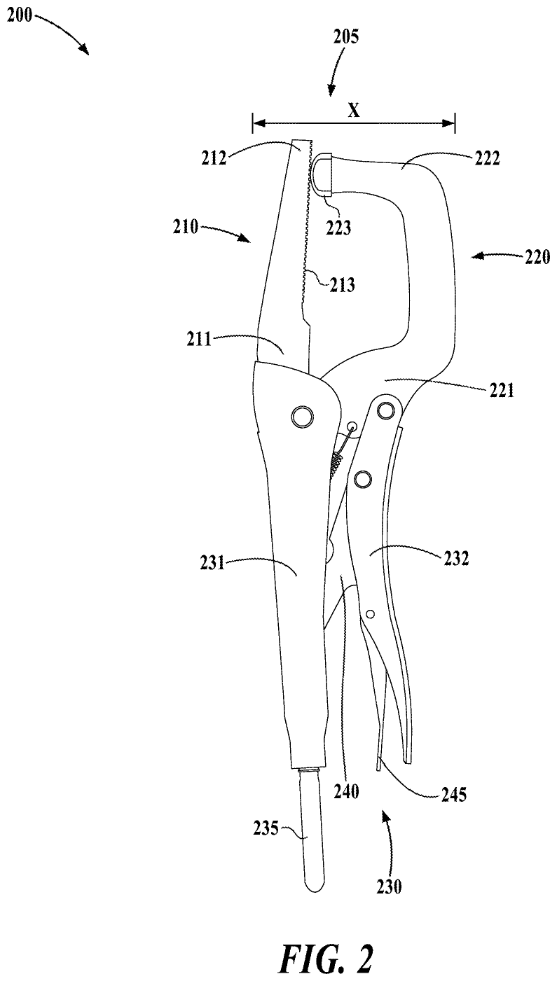

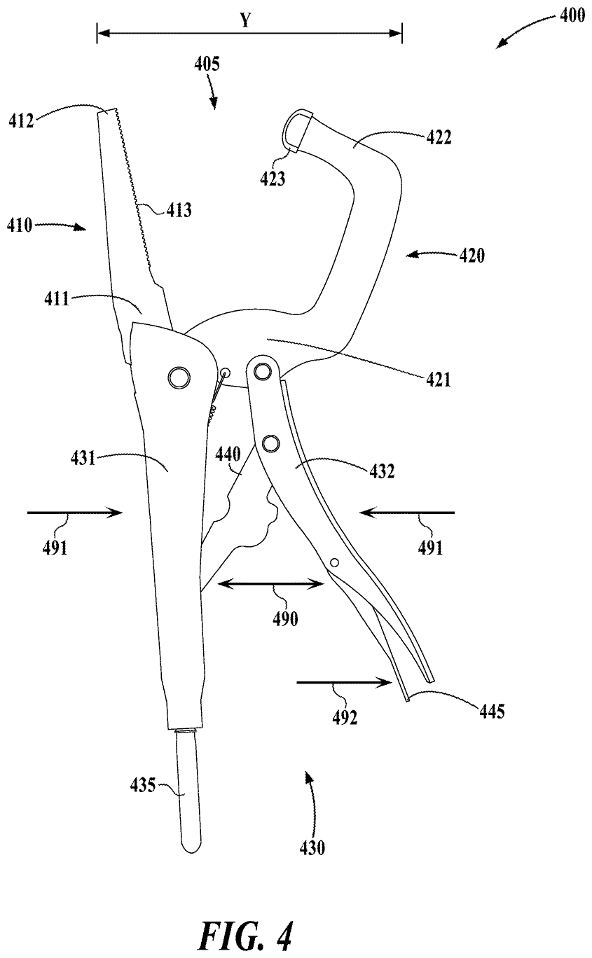

Referring to FIG. 2, an illustration shows a top view of the adjustable locking pliers 200 in a fully closed position in an embodiment of the disclosed adjustable locking plier device. The locking clamp 205 is capable of locking within an infinite range bounded by two positions, including a fully open and fully closed position, the contact portions 213 and 223 of the jaw members 210 and 220, respectively, being furthest from one another in the fully open position (see FIG. 4) and making contact with one another in the fully closed position—as illustrated in FIG. 2. Distance line X denotes the full width of the fully closed clamp 205. In the exemplary embodiment depicted, the straight jaw member 210 is pivoted at its proximal end 211 relative to the handle 230 so that its gripping contact portion 213 (at a region near its distal end 212) makes contact with the terminal contact portion 223 found at the distal end 222 of the angled jaw member 220. The angled jaw member 220 is similarly pivoted at its proximal end 221 relative to the handle 230 so that the locking clamp 205 can assume this position. In an exemplary embodiment, the gripping contact portion 213 is included in the body of the straight jaw member 210 as a shared surface(s), not an external piece that is welded on or mated by some other means, and generally shares the same contours and dimensions as the straight jaw member 210. The straight jaw member 210 is well suited to grip long, flat surfaces of a framing element, such as an exterior surface of a C-Stud. The angled jaw member 220 is well suited to grip irregular surfaces with protruding portions alternately positioned with small flat surfaces, such that the bends in the angled jaw member 220 cradle or avoid the protruding portions, while the terminal contact portion 223 applies ample clamping force to a small available area of the framing element—such as an interior surface of a C-Stud.

The handle 230 comprises a first handle portion 231 and second handle portion 232, both handle portions being in mechanical communication via a spring-loaded locking mechanism 240 that lies between them. Widthwise compression of the handle 230 (see FIG. 4) engages the locking mechanism 240 at a position dictated by the precision tightness adjustor 235, which sets the opening size of the locking clamp 205. The clamp 205 can easily be unlocked by compressing the quick release lever 245.

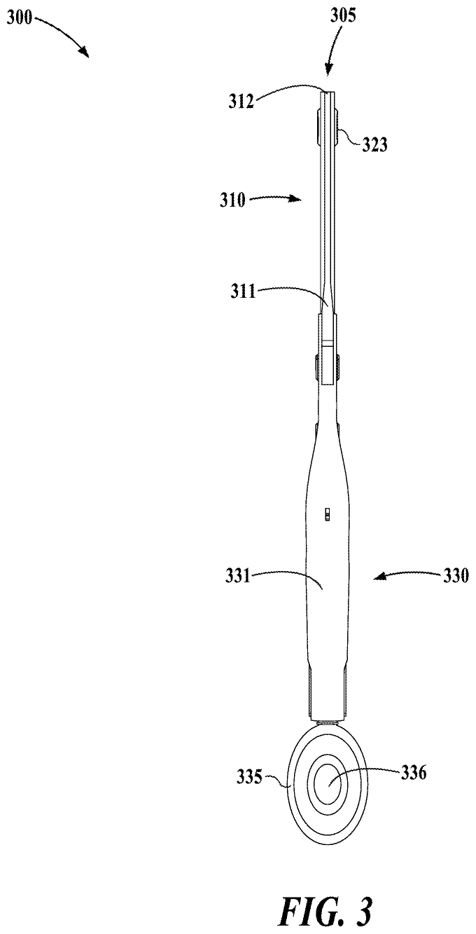

Referring to FIG. 3, an illustration shows a left side view of the adjustable locking pliers 300 in an embodiment of the disclosed adjustable locking plier device. The clamp 305, with straight jaw member 310, generally maintains a slim profile and consistent depth along its length, which generally coincides with the length of the straight jaw member 310 from its proximal end 311 to its distal end 312. The embodiment depicted has an angled jaw member (not seen in this view) with similar or equal depth to that of the straight jaw member 310, making both jaw members substantially flush in that respect, although the terminal contact portion 323 of the angled jaw member slightly exceeds the above-mentioned depth in this example.

The device 300 maintains a minimal profile and depth along its entire length, from distal end 312 to the tightness adjustor 335, and in the embodiment and configuration depicted, the tightness adjustor 335 has the greatest depth among all other elements. However the tightness adjustor 335 can be further rotated out of the position shown, thus further minimizing the depth of the device 300 for insertion into narrow workspaces, especially between walls in framing projects, sound-proofing projects, and other structural modifications involving layered framing materials. The present tightness adjustor 335 is a circular washer-type component with an outer diameter and central opening 336 with inner diameter. When appropriate, a secondary tool such as a metal L-shaped rod or other similar tool can be inserted into the opening 336 for substantially enhanced torque and leverage when manipulating the tightness adjustor 335. This can further assist a user in tight workspaces, where a long secondary tightening tool, rather than the user's hand, can provide more options, and perhaps make the difference in properly installing a framing element and successfully finishing the job. The circular washer-type component is typically welded onto a threaded element which rotatably inserts into the first handle portion 331 of the handle 330. Other embodiments utilize an even smaller washer-type tightness adjustor 335, or a cylindrical type having a cross-hatched grip or similar gripping surface.

Referring to FIG. 4, an illustration shows another top view of adjustable locking pliers 400 in a fully open position in an embodiment of the disclosed adjustable locking plier device. The clamp 405 has its jaw members pivoted at their proximal ends 411 and 421 into a fully open position, so that the gripping contact portion 413 of the straight jaw member 410 lies at the furthest possible point away from the terminal contact portion 423 of the angled jaw member 420. Distance line Y denotes the full width of the fully open clamp, which is largely defined by the positions of the distal ends 412 and 422 of the jaw members 410 and 420, respectively.

The handle 430, with first handle portion 431 and second handle portion 432, further comprises components that are in mechanical communication with the clamp 405, such that manipulating the handle 430 in various ways can lock the clamp 405 into this fully open position and also unlock it from this position. With the clamp 405 set at its current fully open position via rotational adjustment of the tightness adjustor 435, widthwise compression of the handle 430 engages the locking mechanism 440, thus locking the clamp 405 into the position shown. Motion arrows 491 indicate this widthwise compression of the handle 430. Widthwise compression of the quick release lever 445 easily unlocks the clamp 405 from this position. Motion arrow 492 indicates the widthwise compression and activation of the quick release lever 445. Upon activating the quick release lever 445, the first handle portion 431 and second handle portion 432 are loosened and can freely pivot outward and away from each other. Dual motion arrow 490 indicates this widthwise outward expansion of the handle 430 after compressing the quick release lever 445. The fully open and fully closed positions depicted in the illustrations briefly provide the full range of possible clamping positions. Again, the same locking and unlocking activities can be performed at any position within this full range, infinitely.

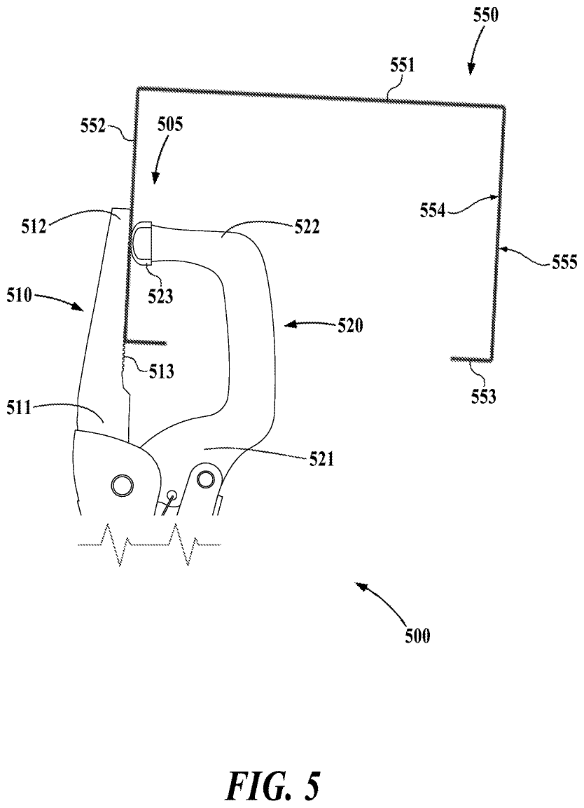

Referring to FIG. 5, an illustration shows yet another top view of adjustable locking pliers 500 clamped onto a metal C-Stud 550 in an embodiment of the disclosed adjustable locking plier device. Framing materials including stud members such as the C-Stud 550 and other furring channels can be installed together in construction projects that involve the installation of inner walls in buildings. Each of these framing materials typically comprises a length of galvanized steel with an opening found along that length. Other types of stud members include CH-Studs, while other types of furring channels include hat channels and resilient channels. The C-Stud 550, presently depicted in top view, further comprises a web 551 with a width, and two flanges 552 extending perpendicularly away from each end of the web 551. Each flange 552 has a depth and a lip 553 extending perpendicularly away from an end of the flange 552 opposite the web 551, the lips 553 having widths and extending toward each other. A gap between the lips 553 forms the above-mentioned lengthwise opening, and the lengthwise opening leads into an inner area with inner surfaces 554 of the lips 553, flanges 552, and web 551, each inner surface 554 having a corresponding outer surface 555.

The clamp 505 can grip the framing material, a C-Stud 550 in this case, via insertion of the angled jaw member 520 into the lengthwise opening found between the lips 553, such that its terminal contact portion 523 makes contact with an inner surface 554 of the framing material. At the same time, the gripping contact portion 513 of the straight jaw member 510 makes contact with an outer surface 555 of the framing material. More specifically, the terminal contact portion 523 of the angled jaw member 520 makes contact with an inner surface 554 of a flange 552, and the gripping contact portion 513 of the straight jaw member 510 makes contact with an outer surface 555 of the same flange 552, with full surface contact being achieved at the distal end 512 and continuing along the gripping contact portion 513 toward the proximal end 511. In some examples, the entire gripping contact portion 513, continuously along its entire length, can maintain full surface contact with the framing material. This continuous full surface contact makes the straight jaw member 510 well suited for achieving a stronger, more reliable locked clamp 505 in smaller spaces where greater care and precision are required. In this clamping configuration, the length at the distal end 522 of the angled jaw member 520 between its terminal contact portion 523 and second (distal) bend is greater than that of the lip 553 extending from the flange 552. The clamp 505 is lockable in this position, and can easily be overtightened for even greater clamping strength. The clamp 505 has its jaw members 510 and 520 slightly pivoted outward at their proximal ends 511 and 521, respectively, in order to grip and lock onto the flange 552 of the C-Stud 550. This clamping position is substantially similar to the aforementioned fully closed position (see FIG. 2), being only slightly more open due to the negligible thickness of the flange 552.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

There may be many other ways to implement the disclosed embodiments. Various functions and elements described herein may be partitioned differently from those shown without departing from the scope of the disclosed embodiments. Various modifications to these implementations may be readily apparent to those skilled in the art, and generic principles defined herein may be applied to other implementations. Thus, many changes and modifications may be made to the disclosed embodiments, by one having ordinary skill in the art, without departing from the scope of the disclosed embodiments. For instance, different numbers of a given element or module may be employed, a different type or types of a given element or module may be employed, a given element or module may be added, or a given element or module may be omitted.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. An adjustable locking plier device, comprising:
(a) a locking clamp, the locking clamp comprising a straight jaw member and an angled jaw member, each jaw member having a length with proximal end, and distal end, the straight jaw member having no points of directional change along its length, the angled jaw member having at least one point of directional change along its length, each jaw member further comprising a contact portion for receiving clamping force, wherein the contact portion of the straight jaw member has at least twice the surface area of that of the angled jaw member and is included in the body of the straight jaw member as a shared surface;
(b) a handle comprising a first handle portion and second handle portion, both handle portions being in mechanical communication via a locking mechanism, wherein the lengths of both the straight jaw member and angled jaw member extend away from the handle starting from their proximal ends;
(c) a tightness adjustor configured to adjust the clamp between a fully open and fully closed position and provide precision over-tightening when the clamp is locked, wherein the first handle portion terminates with the tightness adjustor at the end opposite the locking clamp;
(d) a compressible quick release lever, wherein the second handle portion terminates with the quick release lever at the end opposite the locking clamp; and
wherein both jaw members are pivotally engaged with the handle at their proximal ends, wherein the clamp is configured to lock within an infinite range bounded by the fully open and fully closed positions, the contact portions of the jaw members being furthest from one another in the fully open position and making contact with one another in the fully closed position, and wherein the compressible quick release lever is configured to unlock the clamp from any position within the locking range.

2. The adjustable locking plier device of claim 1, wherein the angled jaw member has two points of directional change along its length, including a first bend at its proximal end, this first bend extending away from the straight jaw member, and a second bend at its distal end, this second bend extending back toward the straight jaw member, wherein the portion lying between the two bends has a length that is over 90% similar to that of the contact portion of the straight jaw member, and wherein the contact portion of the straight jaw member occupies over 90% of the full length of the straight jaw member.

3. The adjustable locking plier device of claim 2, wherein over 90% of the contact portion of the straight jaw member comprises teeth formed by alternating recessed and protruding surfaces, and wherein the contact portion of the angled jaw member is rounded.

4. The adjustable locking plier device of claim 3, wherein the straight jaw member is pivotally engaged with the first handle portion and the angled jaw member is pivotally engaged with the second handle portion.

5. The adjustable locking plier device of claim 4, wherein both contact portions are configured to grip framing materials within the range bounded by the fully open and fully closed positions.

6. The adjustable locking plier device of claim 5, wherein the framing materials include stud members and furring channels each having a length, inner surfaces and outer surfaces, and an opening along the length.

7. The adjustable locking plier device of claim 6, wherein the stud members include C-studs and CH-studs, and the furring channels include hat channels and resilient channels.

8. The adjustable locking plier device of claim 7, wherein the studs each further comprise a web with a width and two flanges extending perpendicularly away from each end of the web, each flange having a depth and a lip extending perpendicularly away from an end of the flange opposite the web, the lips having widths and extending toward each other, a gap between the lips forming said lengthwise opening, and wherein the lengthwise opening leads into an inner area with inner surfaces of the lips, flanges, and web, each inner surface having a corresponding outer surface.

9. The adjustable locking plier device of claim 8, wherein the contact portion of the angled jaw member makes contact with an inner surface of a flange, and the contact portion of the straight jaw member makes contact with an outer surface of said flange, wherein the length at the distal end of the angled jaw member between its contact portion and second bend is greater than that of the lip extending from said flange, and wherein the clamp is lockable in this position.

10. The adjustable locking plier device of claim 6, wherein the clamp is configured to grip a framing material via insertion of the angled jaw member into the lengthwise opening such that its contact portion makes contact with an inner surface of the framing material, and wherein the contact portion of the straight jaw member makes contact with an outer surface of the framing material.

11. The adjustable locking plier device of claim 10, wherein the clamp is configured to grip a framing material via insertion of the straight jaw member into the lengthwise opening such that its contact portion makes contact with an inner surface of the framing material, and wherein the contact portion of the angled jaw member makes contact with an outer surface of the framing material.

12. The adjustable locking plier device of claim 11, wherein the clamp is configured to manipulate the framing materials within a portion of the locking range measuring between ¼ inch and 1½ inches.

13. The adjustable locking plier device of claim 12, wherein the contact portion of the straight jaw member has over four times the length of that of the angled jaw member.

14. The adjustable locking plier device of claim 13, wherein the straight jaw member maintains continuous surface contact along the full length of its contact portion.
